(19) United States
(12) Patent Application Publication
(10) Pub. No.: US 2002/0086715 A1
(43) Pub. Date: Jul. 4, 2002

(54) Wireless earphone providing reduced radio frequency radiation exposure

(76) Inventor: Peter D. Sahagen, San Diego, CA (US)

Correspondence Address: PATE PIERCE & BAIRD, BANK ONE TOWER, SUITE 900, 50 WEST BROADWAY, SALT LAKE CITY, UT, 84101, US

(21) Appl. No.: 09/754,003

(22) Filed: Jan. 3, 2001

(51) Int. Cl. H04M 1/00

(52) U.S. Cl. 455/568; 455/569

(57) ABSTRACT

An apparatus for transmitting acoustic signals from a mobile communication device to the ears of a user and from the mouth of a user to the mobile communication device through a fiber optic link. A principal objective of the apparatus is to substantially reduce or eliminate radio frequency radiation exposure to the cranial regions of users of mobile communication devices. One embodiment of the apparatus implements an earphone and microphone system for use with a mobile telephone or other wireless communication device, using no electrical components within the earphone or microphone. The present invention implements a laser-actuated, sound-producing diaphragm as a hearing device. The laser may be contained within a housing connected to a wireless communication device. The laser may be connected to the hearing device by an optical fiber, thus enabling the housing containing the laser to be at a location remote from the hearing device. The housing may also contain a detector, capable of detecting phase changes corresponding to changes in the length of an optical path caused by modulation of a diaphragm used as a microphone.

### BACKGROUND

1. The Field of the Invention

This invention relates to fiber optic communication systems and, more particularly, to novel systems and methods for reducing radio frequency exposure to the human anatomy by wireless communication devices.

2. The Background Art

The use of mobile telephones and wireless communication devices has increased dramatically in recent years. Such mobile communication devices produce varying degrees of radio frequency radiation during use. The increased use of such mobile communication devices has caused a corresponding increase in the exposure of low level radio frequency radiation to the bodies of users. In particular, users of mobile communication devices are experiencing markedly increased exposure in the cranial area, because many, if not most, mobile communication devices are designed to be held in close proximity to users' ears during use.

The time, duration, frequency, and intensity of such radiation exposure varies widely among users of mobile communication devices, depending on usage patterns and habits of users. For some users, exposure is frequent, prolonged, and intense. The intensity of exposure experienced by a particular user depends to a large extent on the technical characteristics of the mobile communication device used. Moreover, the intensity of radio frequency radiation produced varies greatly among commercially available embodiments of such devices.

In an effort to ameliorate the radio frequency radiation exposure experienced by users and to make mobile communication devices easier to use, remote headphone and speaker systems have been developed and made commercially available. Wires connecting remote headphone or speaker systems to mobile communication devices such as mobile telephones typically extend toward the ears of a users to facilitate reception of signals by users' ears and transmission of voice signals. Such wires are inherently conductors of radio frequency radiation, and these wires typically act as antennas receiving and directing radio signal power into and around the cranial region of users. Remote headphone and speaker systems do not, therefore, adequately abate radio frequency radiation exposure to users of mobile communication devices. “Wireless headsets” or “wireless earphone”, as they are sometimes called, frequently employ radio frequency transmission to deliver signals to the ears of a user from a base mobile communication unit, such as a mobile telephone. Such wireless headsets typically offer the advantage of reduced levels of radio frequency radiation at certain selected frequencies, as compared to radio frequency radiation levels produced by the typical base unit. While wireless headsets offer comparatively low levels of radio frequency exposure at certain frequencies, they actually produce higher levels of radio frequency radiation than the typical base unit at other frequencies. Moreover, “wireless headsets” or “wireless earphones” may be in even closer physical proximity to a user's cranial region during use than the typical base unit or other mobile communication device would be during use. Accordingly, the use of “wireless headsets” may actually increase radio frequency radiation exposure experienced by users of mobile communication devices.

It would be an advancement in the art to provide a method and apparatus capable of remotely transmitting clear audio signals to the ear of a user from a communication device and clear voice signals from a microphone to a communication device, that would reduce or eliminate the radio frequency exposure typically experienced by users of mobile communication devices, particularly mobile telephones. It would be a further advancement in the art to eliminate the use of wires or electrical conductors to transmit signals to and from the cranial area of users of mobile communication devices.

### BRIEF SUMMARY AND OBJECTS OF THE INVENTION

In view of the foregoing, it is a primary object of the present invention to provide wireless earphone systems for use with mobile communication devices that provide reduced radio frequency radiation exposure to users of such communication devices.

It is an object of the invention to provide an apparatus that employs a fiber optic link to transmit acoustic information from a mobile communication device such as a mobile telephone, thereby avoiding the problems associated with the use of wires or other conductors to transmit acoustic information in which the conductors (e.g. wires) direct radio frequency radiation toward the cranial regions of users.

It is also an object of the invention to provide an apparatus that employs an earpiece capable of broadcasting the acoustic information transmitted over the fiber optic link into the ear of a user, thereby avoiding the comparatively higher levels of radio frequency radiation exposure experience by users “wireless headsets” or “wireless earphones” that receive radio frequency transmissions from base mobile communication units.

Consistent with the foregoing objects, and in accordance with the invention as embodied and broadly described herein, a method and apparatus are disclosed, in suitable detail to enable one of ordinary skill in the art to make and use the invention. In certain embodiments, an apparatus in accordance with the invention may include a connector, configured to communicate with a mobile communication device, such as a mobile telephone. The connector may be attached to a housing containing an photonic driver configured to convert an electrical signal to a photonic signal. Accordingly, the photonic signal is transmitted across an optical fiber to a photonic detector, typically housed within an earphone.

In certain embodiments the photonic detector may be a photodiode, phototransistor, photodarlington pair, or a similar element capable of converting a photonic signal to an electrical signal. The earphone may amplify the electrical signal and transmit the signal to a sound producing diaphragm or earphone capable of producing sound within the audible range of a user. Likewise, the earphone may contain a battery to power the amplifier and other components contained within the device. Moreover, certain embodiments of the earphone may include a volume control and a mechanism to conserve power when the acoustic signal falls below a certain threshold value.

In selected embodiments, the apparatus may integrate, into a single integrated system, the earphone with a microphone for receiving acoustic signals. That is, the signal from the microphone may use the same optical fiber as the earphone to transmit back to the mobile phone. The microphone or audio receiver may be configured to convert an acoustic impulse to an electrical signal and then to a photonic signal for transmission across the optical fiber. On the receiving end, a detector may detect the photonic signal and convert it to an electrical signal to produce an input to the mobile communication device (e.g. mobile telephone).

In another selected embodiment, the system may be implemented so that no electrical signals are needed within the earphone and microphone, eliminating the need for a battery within said pieces. Such a configuration eliminates substantially all radio frequency radiation exposure that may be caused by electrical signals within the earphone or microphone. In this embodiment, a laser diode is used in the coupler connected to the mobile communication device to transmit across an optical fiber and actuate a laser driven diaphragm located in the earphone. A detector is also located in the previously mentioned coupler to detect displacements of a diaphragm (e.g. used as a microphone) through an optical fiber.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is perspective view of one embodiment of a an apparatus for reducing radio frequency radiation exposure in accordance with the invention;

FIG. 2 is a schematic block diagram of an audio transmission component of the apparatus of FIG. 1;

FIG. 3 is a schematic block diagram of one embodiment of a microphone component of the apparatus of FIG. 1;

FIG. 4 is a schematic diagram of one alternative embodiment for the audio component of the apparatus of FIG. 1 that uses a sound producing diaphragm remotely located from the earphone;

FIG. 5 is a perspective view of one embodiment of the apparatus integrating both the audio and microphone components;

FIG. 6 is a schematic block diagram illustrating additional detail of the apparatus of FIG. 5; and

FIG. 7 is a schematic block diagram illustrating one embodiment of an integrated system in which neither the earphone nor the microphone use any electronic components.

### DETAILED DESCRIPTION OF THE PREFERRED EMBODIMENTS

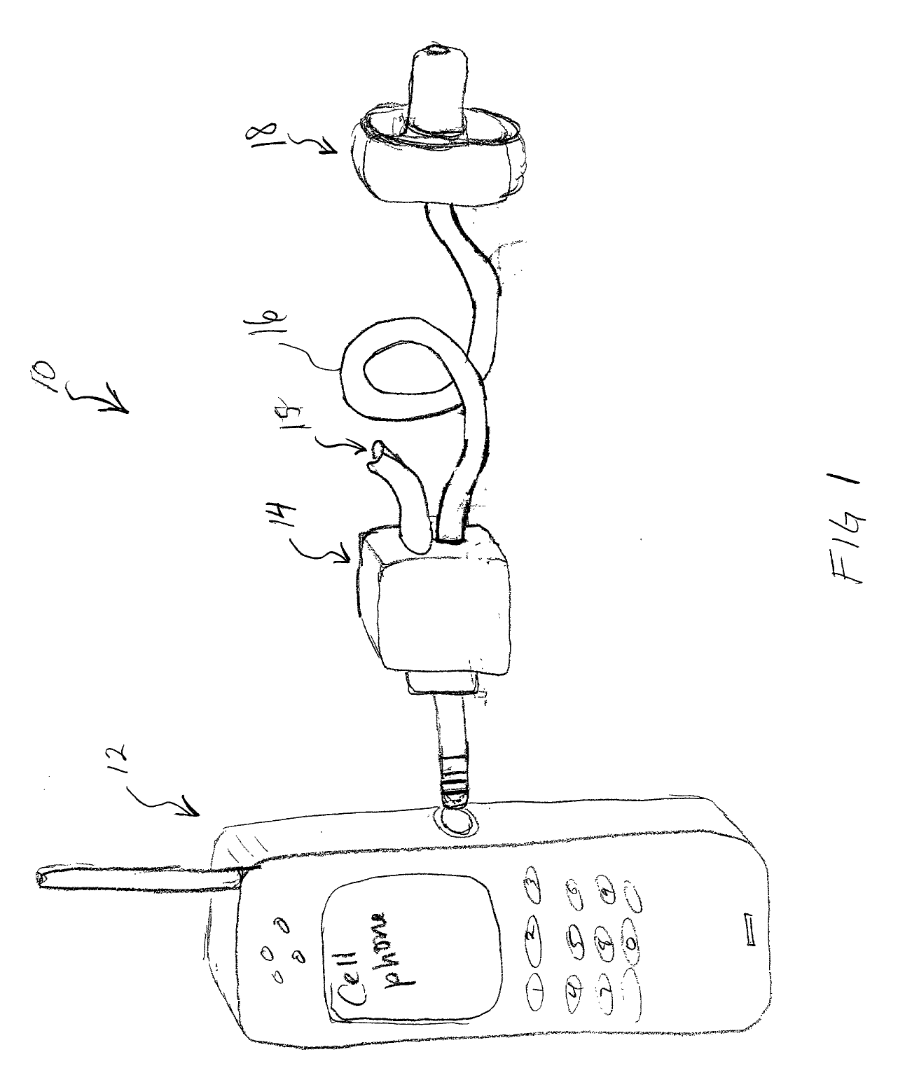

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1 through 7, is not intended to limit the scope of the invention, as claimed, but is merely representative of the presently preferred embodiments of the invention. The presently preferred embodiments of the invention will be best understood by reference to the drawings, wherein like parts are designated by like numerals throughout.

Those of ordinary skill in the art will, of course, appreciate that various modifications to the details of the Figures may easily be made without departing from the essential characteristics of the invention. Thus, the following description of the Figures is intended only by way of example, and simply illustrates certain presently preferred embodiments consistent with the invention as claimed.

Referring to FIG. 1, one presently preferred embodiment of an apparatus 10 for reducing antennae effects in speaker cords may include a coupling element 14 connected to a mobile communication device 12. The coupling element 14 may be configured to modulate an electrical audio signal received from the mobile communication device 12 to a photonic signal for transmission across an optical fiber 16. Accordingly, the photonic signal may be received by an earphone 18 to produce an acoustic impulse corresponding to the hearing range of a listener.

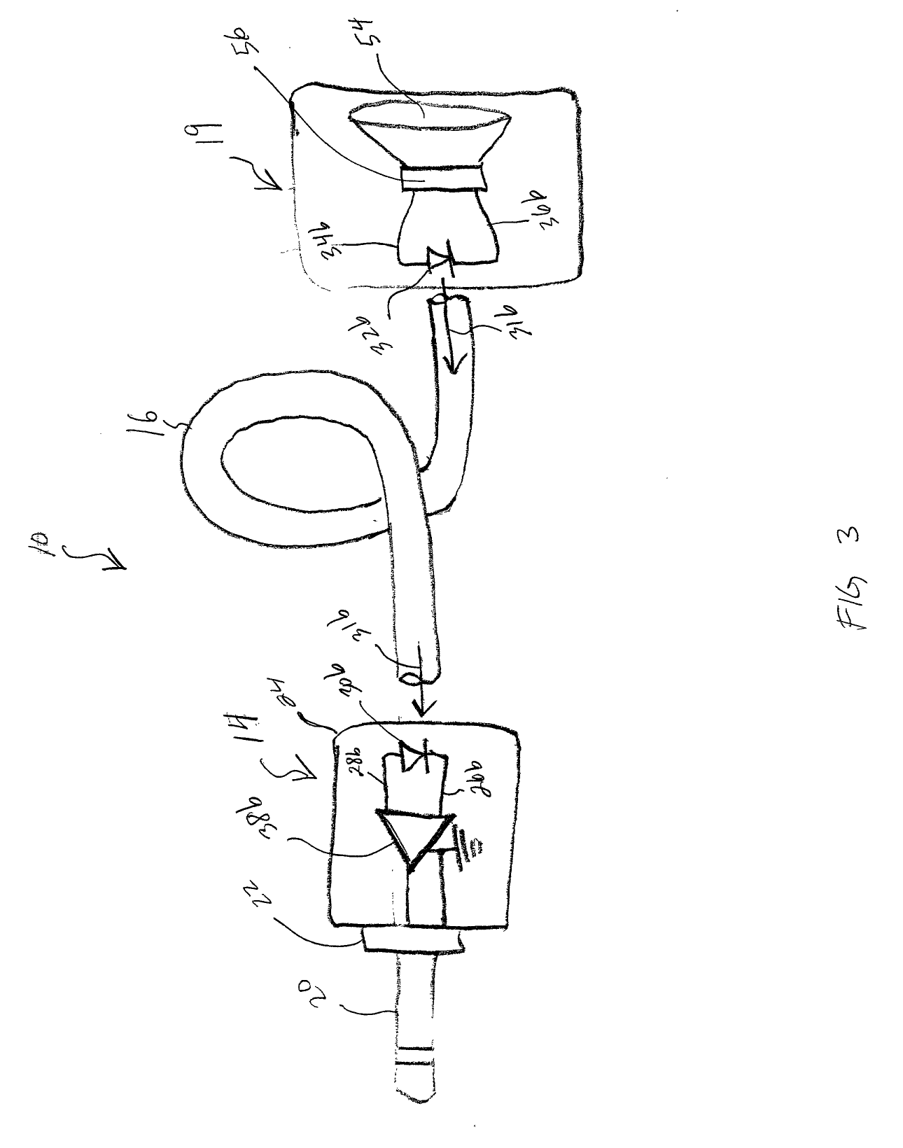

Likewise, another optical fiber 15 may be provided to transmit photonic inputs to the coupler 14 from a microphone (as illustrated in FIG. 3), as desired. The coupler 14 may then convert the photonic inputs from the microphone into electrical audio signals for transmission to the mobile communication device 12.

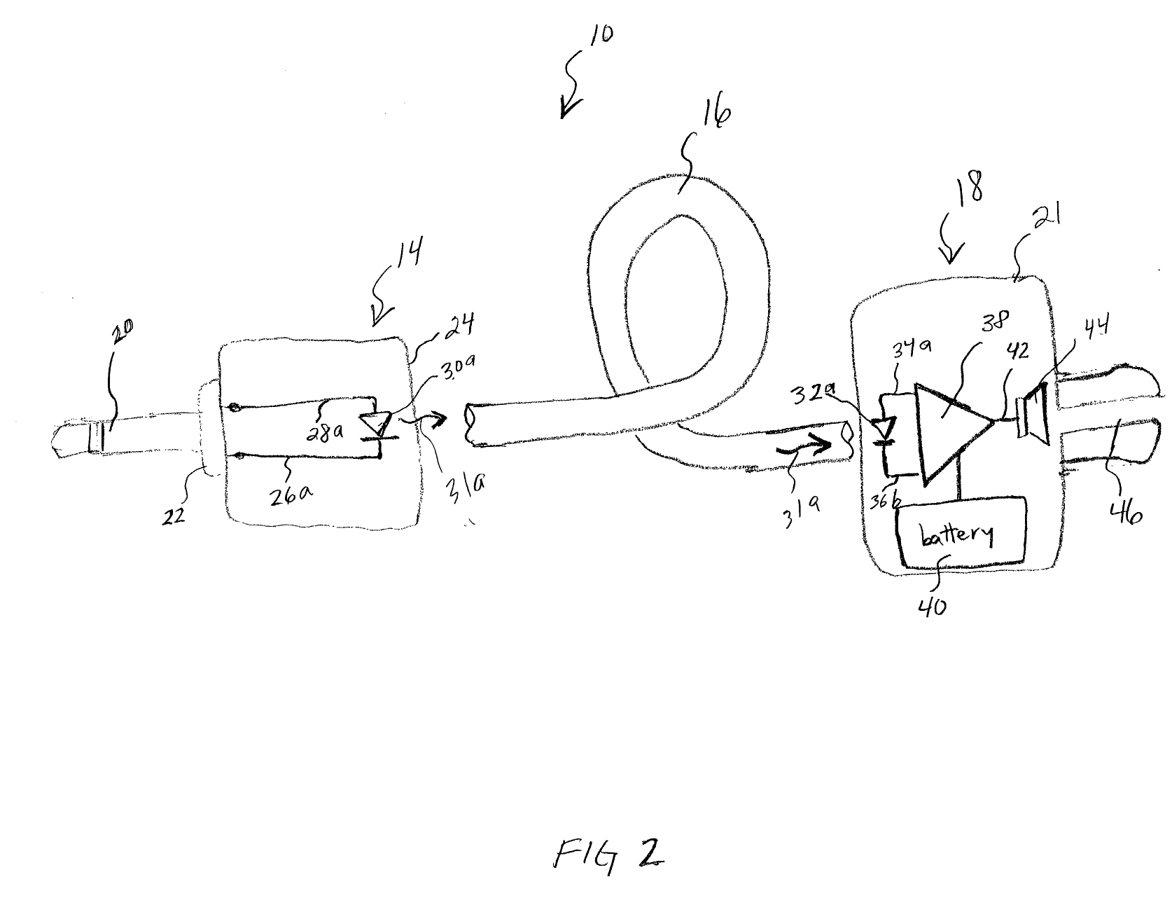

Referring to FIG. 2 while continuing to refer generally to FIG. 1, an apparatus 10 may include a connector 20 for coupling to a communication device 12. Such a connector 20 may comprise a typical cylindrical jack or other type of connector suitable to connect to a corresponding receptacle within the communication device 12. The connector body may attach to a housing 24 enclosing the interior components of a coupling element 14.

The connector 20 may transmit an electrical signal from the communication device 12 through lines 26a, 26b to a conversion element 30a, which may comprise a photodiode, phototransistor, photodarlington pair, or the like, suitable for converting an electrical signal into a photonic signal. In the depicted embodiment, the conversion element 30a converts the electrical signal from the communication device to a photonic signal 31a for transmission across an optical fiber 16 to an earphone 18.

The earphone 18 may comprise a housing 21 containing a detector 32a that receives, detects, and converts the photonic signal 31a into an electrical signal. An amplifier 38 may then amplify and send the electrical signal to a sound producing diaphragm 44 for conversion to an audible impulse. In the depicted embodiment, the audible impulse is projected through an hearing channel 46, which may be attached to the housing 21.

The housing 21 of the earphone 18 may contain a battery 40 to supply power to the amplifier 38. Thus, an audio signal may be transmitted across an optical fiber 16 for eventual reproduction to an audible impulse signal corresponding to the hearing range of a user.

Referring to FIG. 3, another presently preferred embodiment of the apparatus 10 may include an audio receiver 19 or a microphone 19. The microphone 19 may include a diaphragm 54 configured to receive and detect acoustic impulses and an actuator 56 configured to generate an electrical signal corresponding to the acoustic impulses. The microphone 19 may further include a converter 32b configured to convert electrical signals into photonic signals and lines 34b and 36b configured to transmit electrical signals. The converter 32b may comprise a photodiode, phototransistor, photodarlington pair, or the like, suitable for converting an electrical signal into a photonic signal.

For example, in the depicted embodiment, when the diaphragm 54 detects an acoustic impulse (e.g. voice signal or the like), the diaphragm drives the actuator 56 to generate an electrical signal corresponding to the detected acoustic impulse. The electrical signal may be transmitted across lines 34b, 36b to energize the converter 32b, which then converts the electrical signal into a photonic output 31b. The photonic output 31b may be subsequently transmitted over an optical fiber 15 to a remote detector located in a coupling element 14.

When the photonic signal 31b arrives at the coupling element 14, a detector 30b (such as a photodiode, phototransistor, photodarlington pair, or the like) may detect and convert the photonic signal 31b into an electrical signal. The electrical signal may then be transmitted across the lines 26b, 28b to an amplifier 38b to be amplified and sent to a mobile communication device 12 through a connector 20.

In selected embodiments, the signal received from the detector 30b is not amplified, and therefore passes directly from the detector 30b through the lines 26b, 28b to the connector 20 and into the communication device 12. The amplifier 38b may receive power from a power source contained in or associated with the coupling element 14, or, alternatively, the amplifier 38b may receive power from the mobile communication device 12.

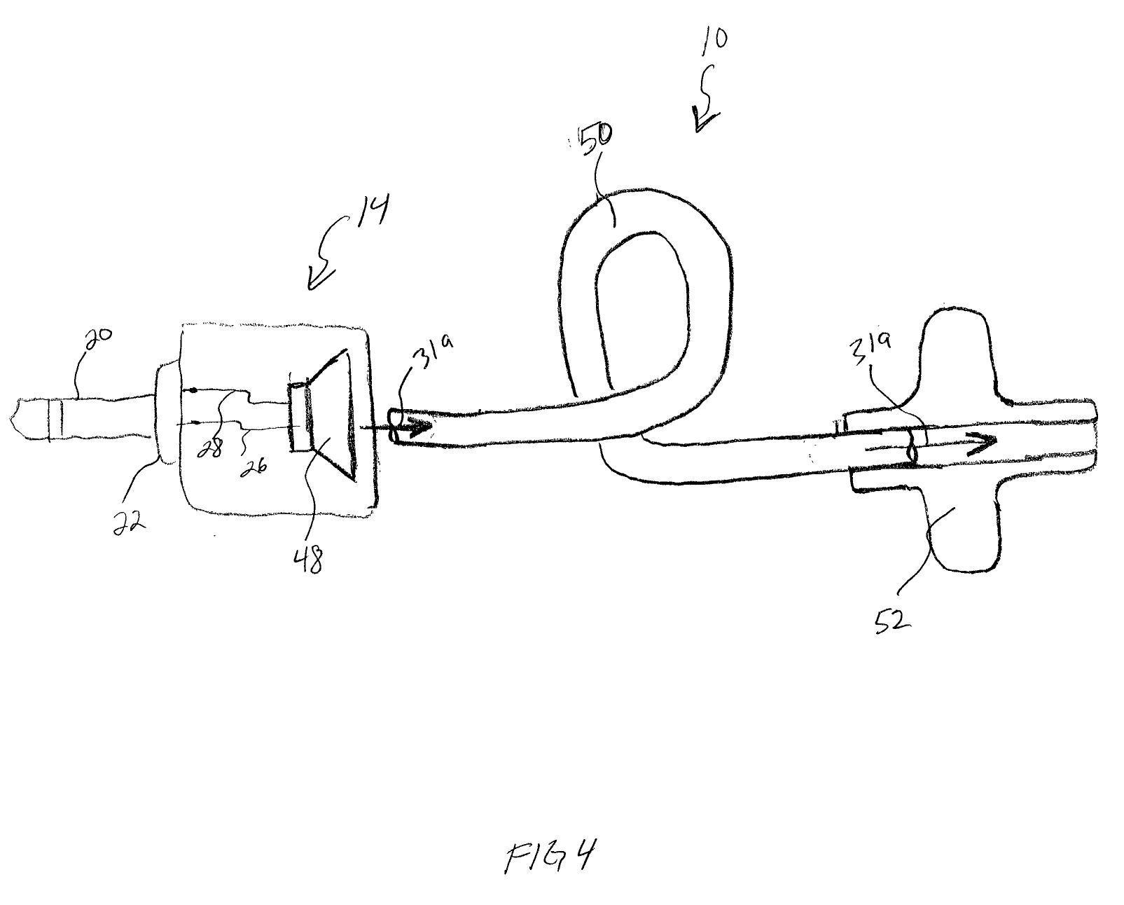

Referring to FIG. 4 while continuing to refer generally to FIGS. 1-3, another presently preferred embodiment of the apparatus 10 may include a sound producing diaphragm 48 located in a coupling element 14. In the depicted embodiment, the sound producing diaphragm 48 may receive an electrical audio signal through lines 26, 28 from a mobile communication device 12. The diaphragm 48 may produce an audible signal 31c, which may be transmitted through a channel 50. The channel 50 may comprise a hollow tube formed of rubber, plastic, or suitable material.

Accordingly, an earphone 52 may receive the audible signal 31c from the channel 50. The earphone 52 typically delivers the audible signal 31c to the ear of a user. The earphone 52 may be configured to modify (e.g amplify or attenuate) the intensity of the audible signal 31c to ensure the audible signal 31c is within the hearing range of a user upon delivery to the user's ear. The embodiment of FIG. 4 may be implemented to eliminate electrical components used in the earphone 52 of the embodiment of FIG. 2.

Likewise, a configuration similar to the configuration of FIG. 4 may be implemented with respect to a microphone 19. In other words, the microphone 19 could be housed within a coupling element 14, which is remote from a user. In such a configuration, a channel 50 may connect a mouthpiece configured to receive a voice input from a user and a coupling element 14 containing a microphone 19. The voice input of a user could thus be transmitted from the mouthpiece through the channel 50 to the microphone 19 housed in the coupling element 14.

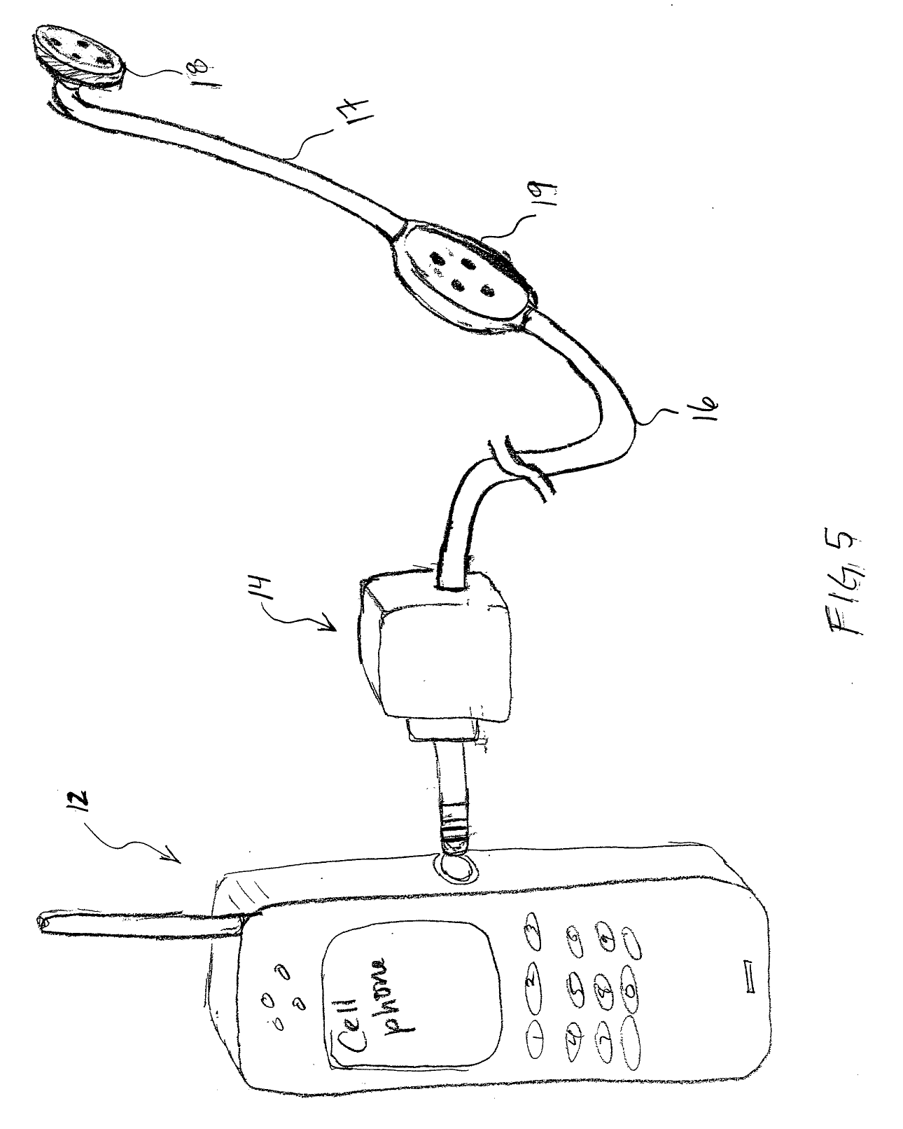

Referring to FIG. 5 while continuing to refer to FIGS. 1-4 generally, another alternative embodiment of the apparatus 10 may include an earphone 18 and a microphone 19 integrated jointly to employ a single optical fiber 16. Since transmission of light signals may be extremely fast and efficient, multiplexing the signals to the earphone and from the microphone may travel over a single optical fiber 16. FIG. 5 illustrates an earphone 18 and microphone 19 merged into a single cord 16 or fiber optic channel 16. However, the apparatus 10 may be implemented in other configurations, such as having separate fiber optic cords to the microphone 19 and earphone 18 or integrating the microphone 19 and earphone 18 into a headset structure.

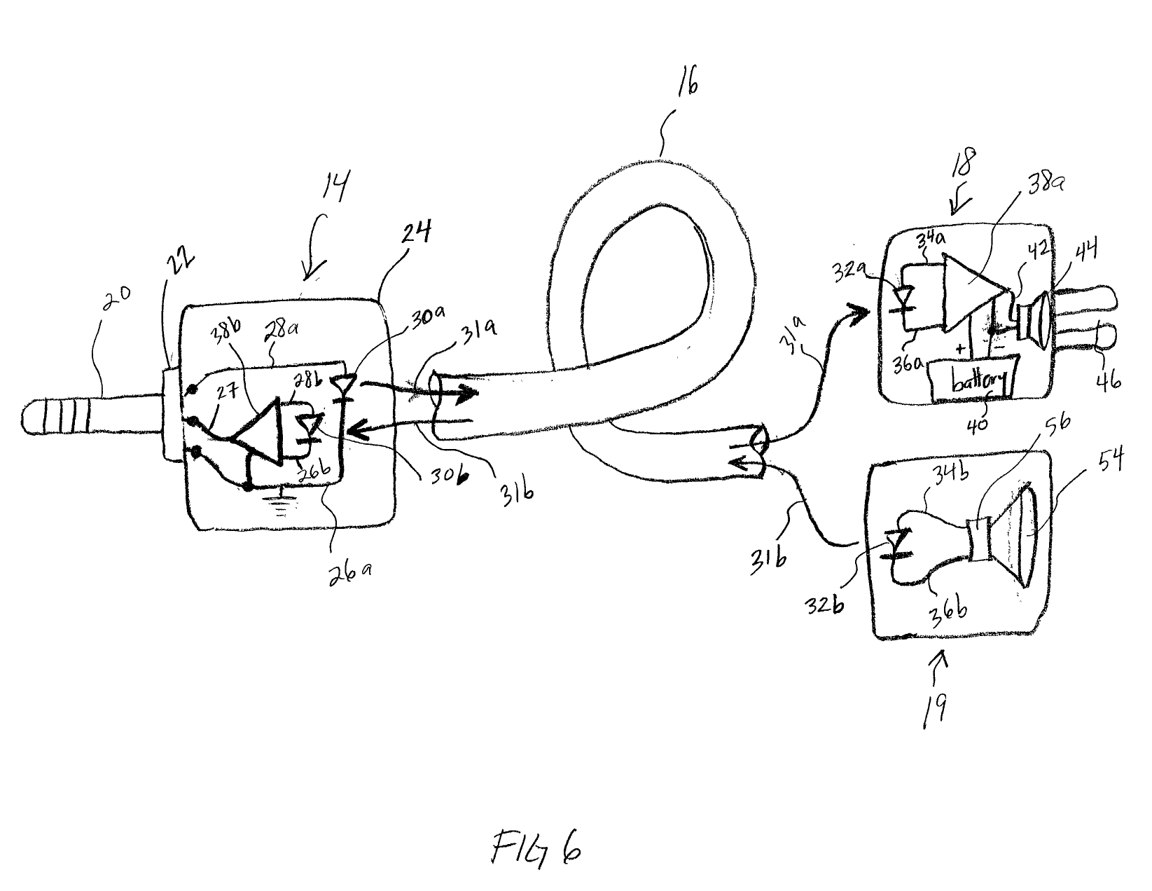

Referring to FIG. 6 while continuing to refer to FIG. 5, a microphone and earphone (as described in FIG. 2 and FIG. 3) may be integrated to use a common optical fiber 16 and coupling element 14. For example, an earphone 18 may be configured to receive a photonic signal 31a across a fiber 16 from a conversion element 30a. Likewise, a microphone 19 may be configured to transmit an audio signal 31b to a detector 30b across the fiber 16. Coupling element 14 may be configured to house both the conversion element 30a and the detector 30b connected to the connector 20 through lines 26a, 27, 28a. Likewise, an amplifier 38b may be included in the housing 24 to amplify the signal from the detector 30b received through lines 26b, 28b.

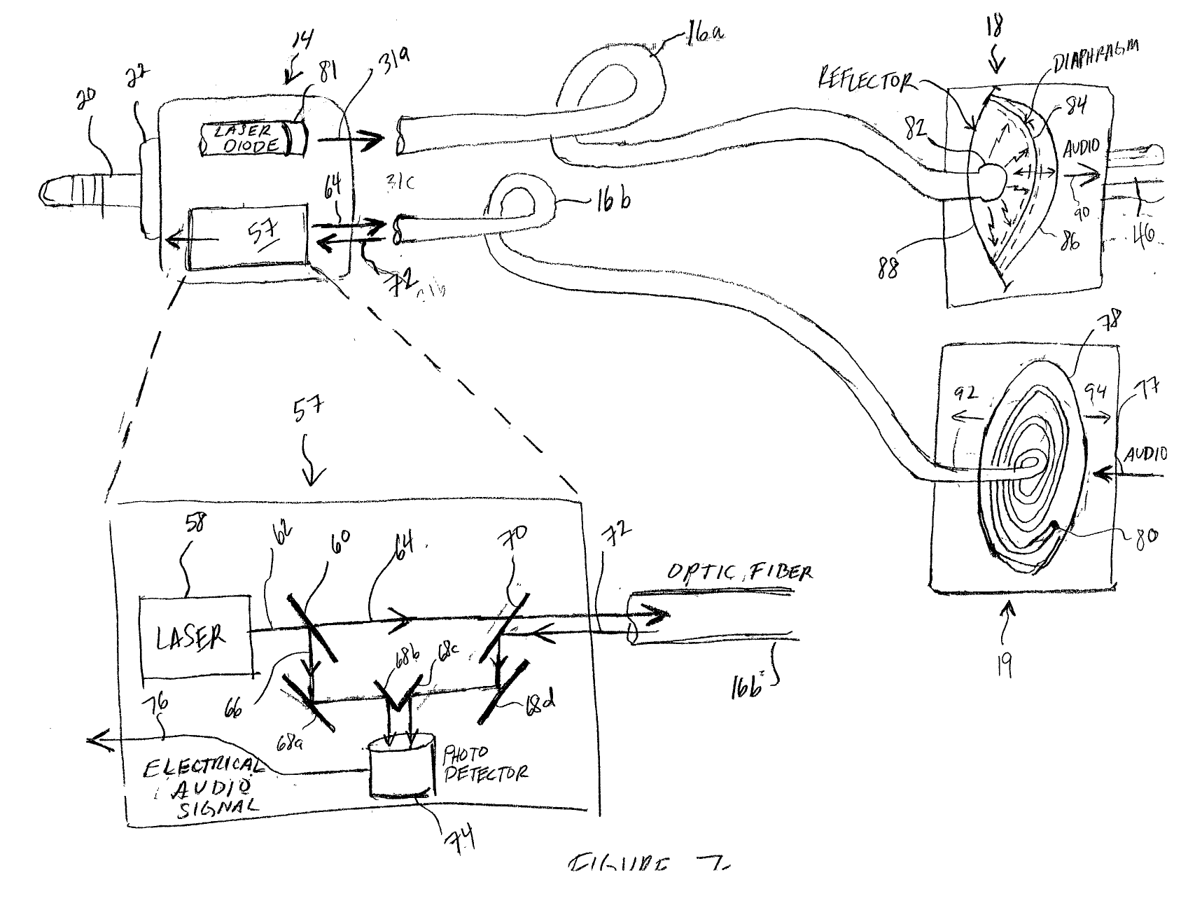

Referring to FIG. 7, one embodiment wherein neither the earphone nor the microphone are comprised of any electrical components, is illustrated. A benefit of implementing the present invention in this configuration is that electromagnetic radiation exposure near the cranial area of a user is greatly reduced or eliminated. A coupling element 14 may comprise a laser diode 81 or laser source 81, which may produce a modulated laser signal 31a containing audio information. The laser signal 31a is transmitted to the end 82 of optical fiber 16a, which is adapted to propagate modulated light from the end 82 thereof to a diaphragm 84.

The diaphragm 84 may be ferromagneticly impregnated and be sustained in a concave posture by a magnetized screen 86. The diaphragm 84 may absorb light received from the end 82 of the optical fiber 16a and, consequently, may be heated or cooled causing expansion or contraction, thus producing a sound field 90. The sound field 90 may then be directed through a hearing channel 46 to the ear of a user.

A reflective shield 88 may be located behind the end 82 of the optical fiber 16a to reflect any excess energy toward the diaphragm 84. Likewise, the end 82 of the optical fiber 16a may be coated with a anti-reflective material to prevent light from reflecting back down the fiber 16a.

The embodiment of FIG. 7 may also include an optically-driven microphone 19. An acoustic impulse 77 corresponding to the voice of a user may be received by the optically driven microphone 19. The acoustic impulse 77 may actuate a diaphragm 78 causing a displacement in directions 92, 94. In the embodiment, an optical fiber 16b is coiled around the diaphragm 78 and is stretched upon displacement of the diaphragm 78 causing the path length of the optical fiber 16b to change. Consequently, a detector 57, positioned in the coupling element 14 may be configured to detect changes in path length and output an electrical audio signal 76 corresponding to modulation of the diaphragm 78.

Referring to the detector 57, a laser reference source 58 may produce apolarized laser output 62 incident on an amplitude splitter 60, which splits the signal into daughter signals 64, 66. The signal 64 passes through a polarization splitter 70 (i.e. transmits light of a specific polarization and reflects light not of that polarization) and travels through the optical fiber 16b, which may be a birefringent fiber in order that the signal 64 maintain a constant angle of polarization. The signal 64 may be transmitted through the optical fiber 16b and reflected by the reflective end 80 of the fiber, configured to change the signal polarization by 90 degrees and produce a signal 72.

The signal 72 is subsequently reflected back towards the detector 57 where it may be incident on the polarization splitter 70 and reflected toward mirrors 68d, 68c into a photodetector 74. Meanwhile, laser reference signal 66 is reflected by mirrors 68a, 68b into the photodetector 74. The photodetector may be configured to compare the two signals 66, 72 and detect any phase change in signal 72 caused by displacement of the diaphragm 78, which alters the path length of fiber 16b. That is, the photodetector 74 may compare the signal 72 to the reference signal 66 to detect any shifts in phase caused by acoustic impulses at the microphone 19. Accordingly, an electrical audio signal is transmitted to the connector 20 corresponding to fluctuations in the diaphragm 78.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed and desired to be secured by United States Letters Patent is:

1. An apparatus for reducing radio frequency radiation effects of mobile communication devices, the apparatus comprising:
an electrical connector configured to receive an input signal, comprising a modulated electrical signal, from a mobile communication device;
a converter configured to convert the input signal to a first photonic signal;
an acoustic device adapted to convert the first photonic signal to an acoustic wave with an audio range corresponding to a hearing range of a user; and
a fiber optic carrier connected to carry the first photonic signal from the converter to the acoustic device.

2. The apparatus of claim 1, wherein the acoustic device comprises an acoustic transducer configured to convert the first photonic signal to a mechanical motion.

3. The apparatus of claim 2, further comprising a microphone operably connected to receive an audio signal corresponding to a voice of a user.

4. The apparatus of claim 3, further comprising a detector remote from the microphone and configured to receive a second photonic signal corresponding to modulation of the microphone.

5. The apparatus of claim 4, further comprising an optical path configured to carry the second photonic signal from the microphone to the detector.

6. The apparatus of claim 5, wherein the microphone further comprises a diaphragm configured to modulate the length of the optical path.

7. The apparatus of claim 6, wherein the detector is connected to provide an electrical output to the mobile communication device, the electrical output comprising a modulated electrical signal corresponding to the voice of a user.

8. The apparatus of claim 7, wherein the optical path is the fiber optic carrier.

9. The apparatus of claim 8, wherein the detector is configured to be powered by the mobile communication device.

10. The apparatus of claim 1, further comprising a microphone operably connected to receive an audio signal corresponding to a voice of a user.

11. The apparatus of claim 1, further comprising a microphone and a detector operably connected to the microphone and spaced remotely therefrom, the detector being configured to receive a second photonic signal corresponding to modulation of the microphone.

12. The apparatus of claim 1, further comprising a microphone and a detector operably and remotely connected to communicate over an optical path extending therebetween.

13. The apparatus of claim 1, further comprising a microphone configured to modulate the length of an optical path.

14. The apparatus of claim 1, further comprising a detector configured to produce a second modulated electrical signal corresponding to the voice of a user to the mobile communication device.

15. The apparatus of claim 1, further comprising a microphone and a detector operably connected to communicate over the fiber optic carrier.

16. A method for reducing radio frequency radiation effects of mobile communication devices, the method comprising the steps of:
providing a first electrical signal corresponding to a speaker input from a mobile communication device;
converting the first electrical signal to a first photonic signal;
transmitting the first photonic signal to an acoustic device across a fiber optic carrier; and
converting the first photonic signal to a first acoustic signal.

17. The method of claim 16, further comprising the step of transducing the first photonic signal to a mechanical motion.

18. The method of claim 17, further comprising the step of providing a microphone for receiving a second acoustical signal corresponding to a voice of a user.

19. The method of claim 18, further comprising the step of remotely detecting a second photonic signal corresponding to modulation of the microphone.

20. The method of claim 19, further comprising the step of optically transmitting the second photonic signal from the microphone.

21. The method of claim 20, further comprising the step of modulating the length of an optical path from the microphone.

22. The method of claim 21, further comprising the step of converting the second photonic signal into a second electrical signal for input into a mobile communication device, the second electrical signal corresponding to the voice of a user.

23. The method of claim 22, wherein the second photonic signal is optically transmitted across the fiber optic carrier.

24. The method of claim 16, further comprising the step of providing a microphone operably connected to receive an audio signal corresponding to a voice of a user.

25. The method of claim 16, further comprising the step of providing a microphone and a detector connected to the microphone and spaced remotely therefrom, the detector being configured to receive a second photonic signal corresponding to modulation of the microphone.

26. The method of claim 16, further comprising the step of providing a microphone and a detector operably and remotely connected to communicate over an optical path extending therebetween.

27. The method of claim 16, further comprising the step of providing a microphone configured to modulate the length of an optical path extending therefrom.

28. The method of claim 16, further comprising the step of providing a detector and amplifying a signal between the detector and the mobile communication device.

29. The method of claim 16, further comprising the step of providing a detector configured to produce a modulated signal corresponding to a voice of a user to the mobile communication device.

30. The method of claim 29, further comprising the step of amplifying the modulated signal with power from the mobile communication device.

31. The method of claim 16, further comprising the step of providing a microphone and a detector operably and remotely communicating over the fiber optic carrier.
